(19) United States
(12) Patent Application Publication
(10) Pub. No.: US 2025/0008215 A1
(43) Pub. Date: Jan. 2, 2025

(54) METHOD FOR GENERATING AND PROCESSING IMAGE DATA

(71) Applicant: Arnold & Richter Cine Technik GmbH & Co. Betriebs KG, München (DE)

(72) Inventor: Achim OEHLER, München (DE)

(21) Appl. No.: 18/753,225

(22) Filed: Jun. 25, 2024

(30) Foreign Application Priority Data
Jun. 30, 2023 (DE) 102023117296.4

(51) Int. Cl. H04N 23/66; H04N 23/55

(52) U.S. Cl. CPC H04N 23/66; H04N 23/55

(57) ABSTRACT

In a method for generating image data by means of a camera, which comprises an image sensor that has a plurality of light-sensitive sensor cells arranged in rows and columns, and for processing the image data by means of an external image processing device, the following steps are provided: providing camera specimen-specific data about determined properties of the camera that may deviate from camera model-generic properties of the camera; controlling the image sensor to generate respective image signal values in dependence on the intensity of the light incident on the sensor cells; reading out the image signal values and generating preliminary image data from the image signal values in the camera; transmitting the preliminary image data to the external image processing device together with metadata that comprise the camera specimen-specific data or at least allow an assignment of the camera specimen-specific data to the preliminary image data; and generating processed image data by means of the external image processing device by applying a correction dependent on the camera specimen-specific data to the preliminary image data.

The invention relates to a method for generating image data and subsequently processing the image data.

Image data may be generated by means of a camera, wherein the camera may in particular be a motion picture camera that generates, as image data, a sequence of frames that are recorded at a specific frame repetition rate (also called a frame rate). In this respect, the camera may be configured as an electronic camera and may comprise an image sensor that has a plurality of light-sensitive sensor cells arranged in rows and columns. The camera may further have readout electronics. Depending on the intensity of the light incident on the sensor cells, the image sensor may generate respective image signal values that may be read out and/or further processed by the readout electronics. An image may then be generated (in various ways) from the image signal values and, corresponding to the image sensor, may have a plurality of picture elements (pixels) that are arranged in rows and columns and that each correspond to one of the sensor cells.

The image signal values read out from the image sensor are initially raw image data that may not necessarily be displayed directly as a high-quality image. For example, the image sensor may be provided with a color filter matrix that, in accordance with a predefined color pattern, in each case only allows light of a specific range of the color spectrum to pass through to the individual sensor cells. As a result, each of the sensor cells of the image sensor is assigned, according to the color filter matrix, to a respective one of a total of, for example, three or four different color channels that are defined by the respective range of the color spectrum that is transmitted by the color filter. In this respect, the use of a so-called Bayer filter is widespread in which, in each case of four sensor cells arranged in two rows and two columns, two sensor cells arranged diagonally to one another are provided with a green-transmitting color filter and, of the two remaining sensor cells, one is provided with a red-transmitting color filter and the other with a blue-transmitting color filter. Therefore, with such raw image data, only a single image signal value assigned to a single color channel is initially present for each pixel, wherein the image signal values of adjacent pixels are assigned to different color channels. To be able to display a realistic image based on these raw image data, further image signal values must therefore be determined for each pixel by interpolation (so-called demosaicing) from image signal values of adjacent pixels, said further image signal values being assigned to the remaining color channels to which the image signal value of the respective pixel is not assigned.

For cameras of a specific camera model, the color filter used in the respective camera model is usually known as a camera model-generic property of the camera or the image sensor, and it may be assumed with certainty that the respective color filter is actually used in each camera of the respective camera model. However, other camera model-generic properties that must likewise be considered for generating a high-quality image from the image signal values generated by the image sensor or from the raw image data generated from said image signal values are not equally certain.

For example, a fixed nominal relationship, which is in particular the same for all sensor cells, between the intensity of the light incident on a respective sensor cell and the image signal value consequently generated by the respective sensor cell may indeed be defined as a camera model-generic property of the camera. Such a nominal relationship may be specified as a generic property for a plurality of specimens of a camera model (i.e. a type). However, the actual relationship may deviate from the nominal relationship, for instance due to production tolerances, and indeed generally to a different extent for each sensor cell. Furthermore, individual sensor cells and/or individual amplifiers of the image sensor or parts of the downstream readout electronics of a respective camera specimen may be defective. Such deviations of the actual properties from the camera model-generic properties may lead to disruptive artifacts in the image data so that, for the generation of a high-quality image from the image data, it is endeavored to fully compensate the deviations, ideally by a corresponding correction.

As a rule, it is therefore necessary to determine, for instance as part of a calibration, the actually present properties of the camera, in particular of the image sensor and/or of the individual sensor cells and/or of the readout electronics, which may deviate from the camera model-generic properties of the camera, separately for each individual camera specimen of a camera model. The result of such a calibration, which may, for example, be stored in the camera, may then be used for a correction of disturbances in the image data that result from deviations between the actual properties and the camera model-generic properties.

Electronic cameras often comprise an integrated image processing device that may be realized by special software and/or hardware and that is configured to perform said interpolation and/or said correction in order, as a result, to generate processed image data that may then be directly displayed (for example on a display unit provided at or connected to the camera), stored and/or output as a high-quality image. However, such a camera-internal image processing requires a sufficiently high computing power of the camera that must comprise correspondingly complex hardware and/or software for this purpose. In this respect, the computing effort increases with the quality requirements just as with parameters such as the resolution (number of pixels) and the frame repetition rate that generally continue to increase in the course of technological progress and demands. As a result, the complexity and thus the costs and power requirements of the camera increase.

To avoid this, it is conceivable to outsource from the camera that part of the image processing which does not depend on camera specimen-specific data such as said deviations between the determined (actual) and the camera model-generic (nominal) properties. For each camera specimen of a respective camera model may then provide image data that may be uniformly processed to produce a high-quality image. The computing effort to be made in the camera is thereby indeed reduced, but it remains comparatively high due to the correction of said deviations that is still performed in the camera—in particular in the case of quality requirements such as those placed on the ultimately resulting image in professional film productions.

It is an object of the invention to provide a method for generating and processing image data that is suitable for minimizing the complexity of data processing in the camera and for satisfying high quality requirements for the resulting image.

The object is satisfied by a method having the features of the independent claims. Advantageous further developments of the invention result from the dependent claims, the present description, and the Figures.

The method according to the invention relates to the generation of image data, in particular moving image data, by means of a camera and the processing of the image data by means of an external image processing device. In this respect, the camera comprises an image sensor, which (as described above) has a plurality of light-sensitive sensor cells arranged in rows and columns, and readout electronics arranged downstream of the image sensor.

The method comprises providing camera specimen-specific data about determined properties of the camera that may deviate from camera model-generic properties of the camera. In particular, camera specimen-specific data about deviations of the determined properties from the camera model-generic properties may be provided in this respect. The camera specimen-specific data about determined properties of the camera may only refer to a part of the camera, for example to the image sensor per se, to the individual sensor cells of the image sensor, to integrated signal amplifiers of the image sensor, to integrated analog-to-digital converters (A/D converters) of the image sensor, to the readout electronics of the camera per se, or to parts of the readout electronics. The readout electronics of the camera may comprise various components that are arranged outside the image sensor, for example, on a common circuit board or in a distributed manner. The readout electronics of the camera may, for example, comprise amplifiers, analog-to-digital converters or electronic components for signal processing or control, e.g. an integrated circuit (IC); a microprocessor; a central processing unit (CPU); a graphics processing unit (GPU); an application-specific integrated circuit (ASIC); and/or or a field programmable gate array (FPGA).

The determined properties may in particular be actually present properties of the camera (in particular of the image sensor and the readout electronics) as opposed to merely nominal properties of the camera (as explained above). The determination of the properties is in this respect not necessarily part of the method according to the invention, but may have already taken place beforehand, for instance by a separate calibration procedure that may, for example, already have been performed by the manufacturer of the camera after its manufacture. However, the method according to the invention may generally also comprise the determination of the (actual) properties that then takes place before the provision of the camera specimen-specific data.

Said properties of the camera may have an effect, in particular an at least substantially uniform effect, on all data obtained by means of the image sensor or only on a portion of the obtained data, e.g. on one or more respective rows or columns of sensor cells of the image sensor.

In some embodiments, said properties of the individual sensor cells may be limited to having an effect on the data obtained by means of the respective sensor cell. The determined properties of the individual sensor cells may in particular be present in the form of a (calibration) matrix that has a number of rows and columns corresponding to the image sensor and comprises one or more correction parameters and/or pieces of status information for each sensor cell of the image sensor (for example, whether the respective sensor cell is defective or not). Non-linear characteristic curves of the sensor cells may in particular also be parameterized by such a matrix, as will be explained below.

The provision of the camera specimen-specific data may in particular take place by storing the camera specimen-specific data in the camera, in an external database and/or in another memory. Advantageously, the camera specimen-specific data are in this respect assigned identification information via which the respective camera specimen or its relevant components (in particular the image sensor and/or the readout electronics or parts thereof), to which the camera specimen-specific data relate, may be uniquely identified.

The method further comprises controlling the image sensor to generate respective image signal values in dependence on the intensity of the light incident on the light-sensitive sensor cells. In particular, each of the sensor cells, provided it is not defective, in this respect generates one or (successively) more image signal values in dependence on the intensity of the light incident on said sensor cells. In this respect, the image sensor is preferably controlled so that all sensor cells generate image signal values synchronized with a specific predefined frame repetition rate.

The method further comprises reading out the image signal values and generating preliminary image data from the image signal values in the camera. The image signal values may essentially be read out directly from the image sensor. This may in particular comprise digitizing, by means of A/D converters, analog image signals which are generated by the sensor cells in the image sensor, which may be amplified and on which the image signal values are based. From the read-out image signal values, image data are then generated that may be subject to errors and include artifacts, in particular due to possible deviations of said determined properties from the camera model-generic properties, and are therefore designated as preliminary image data.

The generation of these preliminary image data may in particular comprise combining the image signal values into a sequence of frames. In this respect, a certain pre-processing of the image signal values, such as the application of a non-linear pre-amplification (pre-emphasis), may generally already take place. Furthermore, an interpolation of said kind (demosaicing) may generally also be performed, wherein this is not necessarily the case and the interpolation may also be performed at a later point in time, in particular only outside the camera. Preferably, however, no correction of errors and artifacts that result from said deviations takes place when generating the preliminary image data.

However, in some embodiments, it is also possible that the preliminary image data are (inter alia) preliminary in that at least one correction (of possibly a plurality of total provided corrections) indeed takes place, but is only performed incompletely. For example, to conceal deviations between amplifiers of the image sensor, in particular row or column amplifiers, the image signals may be subjected to a scrambling (described in more detail below) before they are amplified, wherein the correction is then still incomplete until the scrambling is reversed again after the amplification (descrambling).

Furthermore, the method comprises transmitting the preliminary image data to the external image processing device together with metadata that comprise the camera specimen-specific data or at least allow an assignment of the camera specimen-specific data to the preliminary image data. In this respect, the image processing device is in particular an external image processing device in that it is not integrated into the camera.

The preliminary image data and the metadata may in this respect be transmitted directly or indirectly (via one or more intermediate devices) from the camera to the external image processing device. The transmission may take place in a wired or wireless manner or even partly in a wired and partly in a wireless manner. A transmission by means of one or more data carriers on which the data (the preliminary image data and the metadata) are stored may also be considered so that the transmission of the data may be decoupled in time from the recording. Even if the transmission does not take place via data carriers, but rather via a data connection, the data do not necessarily have to be transmitted directly after their generation, but provision may be made that the data are first temporarily stored in the camera.

Furthermore, it may be provided that the data are compressed, in particular for a respective transmission, wherein they are then preferably first decompressed again before a further processing.

The metadata may be specifically assigned to the image data; however, the metadata are not part of the image data, but rather include additional information that goes beyond the image information included in the image data, namely in particular said camera specimen-specific data. However, the metadata may be integrated into the preliminary image data in that they may be combined with the preliminary image data in a single file or a single data stream. Alternatively thereto, the metadata may, however, also be available separately from the preliminary image data and may be transmitted separately in this regard. The fact that the preliminary image data are transmitted together with the metadata therefore does not necessarily mean that the preliminary image data and the metadata are transmitted in combination, but in particular that both the preliminary image data and the metadata are transmitted to the external image processing device, preferably simultaneously or at least sequentially in time, and are in this respect related to one another, for example in that the metadata include a reference to the preliminary image data and/or, conversely, the preliminary image data include a reference to the metadata.

The metadata do not necessarily have to comprise the camera specimen-specific data themselves. For it may, for example, be sufficient for the metadata to comprise identification information about the camera (in particular of the image sensor and/or the readout electronics or parts thereof), i.e. information based on which the camera specimen used to generate the preliminary image data or its image sensor may be uniquely identified. This identification information may then be used to assign camera specimen-specific data already present in the external image processing device to the preliminary image data or to obtain the camera specimen-specific data from elsewhere, for example from an external database (which will be described in more detail below). In this way, the camera specimen-specific data may therefore be assigned to the preliminary image data based on the metadata without themselves having to be included in the metadata transmitted together with the preliminary image data.

The method furthermore comprises that the external image processing device generates processed image data by applying a correction dependent on the camera specimen-specific data to the preliminary image data. The processed image data are therefore generated from the transmitted preliminary image data, namely by applying a correction to the preliminary image data that serves to eliminate errors and artifacts that may result from said deviations between the determined properties and the camera model-generic properties. This correction includes the camera specimen-specific data that were transmitted together with the preliminary image data or that were assigned to the preliminary image data after they were already present in the external image processing device or were obtained from elsewhere; for example, the camera specimen-specific data may be included as parameters in the respective correction. If a correction already takes place when generating the preliminary image data, but was only performed incompletely, the application of the correction dependent on the camera specimen-specific data may also comprise completing this previously incomplete correction, wherein even the mere completion is preferably still dependent on the camera specimen-specific data.

The fact that the correction applied to the preliminary image data is dependent on the camera specimen-specific data in this respect has the additional advantage that the availability of the camera specimen-specific data is a prerequisite for applying the correction. If the metadata do not directly comprise the camera specimen-specific data, but only comprise identification information or allow an assignment of the camera specimen-specific data to the preliminary image data in another way, it may thus be advantageously controlled, by restricting access to the camera specimen-specific data, who may apply the correction dependent on the camera specimen-specific data in order to generate processed image data of very high quality. For example, an access key (e.g. a license key) may additionally be required to access the camera-specific data (possibly in addition to the identification information to retrieve the correct data, i.e. data relating to the respective camera). Or it may be ensured that the correction dependent on the camera specimen-specific data may generally only be performed by a limited number of authorized persons, in particular only by the camera manufacturer. The correction dependent on the camera specimen-specific data may thus be performed at different authorization and quality levels.

Once the processed image data have been generated, they may then be output by the external image processing device.

The generation of the processed image data is not limited to said correction dependent on the camera specimen-specific data. Rather, the generation of the processed image data may additionally comprise other image processing and image preparation steps that may be independent of the camera specimen-specific data. If the image data comprise a plurality of color channels and the preliminary image data do not yet include values in all the color channels for each pixel of the image data, the generation of the processed image data may in particular also comprise an interpolation (demosaicing) in order to add, for each pixel, the values in those color channels in which no values are yet available for the respective pixel. However, such an interpolation may also already take place in the camera as part of the generation of the preliminary image data from the image signal values and may thus no longer necessary when generating the processed image data. Furthermore, the processed image data may generally still be uninterpolated, i.e. have a plurality of color channels, but only have a value in a respective one of the color channels (for instance according to said Bayer filter) for each pixel.

Due to the method according to the invention, the camera advantageously does not have to be configured to generate fully processed image data of a very high quality so that the computing effort to be made by the camera may remain comparatively low. The camera may thereby have a reduced complexity compared to conventional cameras. However, it is simultaneously ensured by the metadata that the image processing may be performed or completed outside the camera, namely in the external image processing device, based on the required camera specimen-specific data, to correct possible errors or artifacts due to deviations between the actual and nominal properties of the specific camera specimen and thus, ultimately, to obtain high-quality image data. Since the metadata, in particular the camera specimen-specific data, generally apply globally, i.e. to the entirety of the image data recorded with the respective camera specimen, or at least remain constant over time, for example for the duration of a respective recording sequence, the volume of the metadata is small compared to the data volume of the image data so that the additional transmission of the metadata themselves then does not result in a substantial additional effort even if the camera specimen-specific data are directly included in the metadata.

Said correction applied to the preliminary image data may comprise one or more types of a correction of image data (possibly raw image data). For example, an offset correction and/or a gain correction may take place in which a gain, which is included in the readout of the image signal values and/or the generation of the preliminary image data from the image signal values, is corrected by a correction offset or correction factor that is in particular individually predefined for each sensor cell.

A more complex correction may comprise the correction factor being signal-dependent. For example, the gain of the image signal values of the individual sensor cells may be corrected based on a non-linear characteristic curve, wherein the parameters of the characteristic curve are preferably individually predefined for each sensor cell. The various image signal values may then be transformed by means of the individual characteristic curve for the respective sensor cell.

Furthermore, a correction may take place by which it is compensated that some of the sensor cells are defective, for example by replacing values of pixels in the preliminary image data that correspond to a defective sensor cell with estimated values, such as those determined by interpolation from values of adjacent pixels.

In this regard, an embodiment of the invention is advantageous in which the camera specimen-specific data comprise gain correction offsets of the sensor cells, gain correction factors of the sensor cells, parameters of non-linear characteristic curves of the sensor cells and/or status information about defective sensor cells. A gain correction offset or gain correction factor of a respective sensor cell is in this respect an offset or a factor for correcting a gain that is included in the readout of an image signal value generated by means of the respective sensor cell or in the generation of the preliminary image data (inter alia) from this image signal value and that may be erroneous due to said possible deviations between the determined properties and the camera model-generic properties.

As an alternative or in addition to applying a gain correction offset or a gain correction factor, a non-linear correction may also be applied to the image signal values by means of a characteristic curve that is preferably individually defined for each sensor cell. A signal-dependent correction may hereby be applied to the image signal values of the image sensor or to the preliminary image data generated therefrom. Such a characteristic curve may in each case assign a modified image signal value to different image signal values and in this regard corresponds to a (non-linear) transformation of the image signal values. The respective characteristic curve may, for instance, be defined as a function or as a lookup table that is preferably based on the results of a calibration of the respective image sensor. To be able to define an individual characteristic curve for all sensor cells and nevertheless minimize the amount of camera-specific data, the characteristic curve may be partly defined in the same way for all sensor cells, for instance by determining support points of the characteristic curve (to approximate the result of the calibration) which are identical for all sensor cells and to which the characteristic curves of the sensor cells are therefore so-to-say “constricted”. However, the characteristic curves are preferably also at least partly defined by sensor cell-specific parameters by which in particular the course of the respective characteristic curve between two respective support points for each sensor cell may be individually predefined.

The gain correction offsets and the gain correction factors or the sensor cell-specific parameters of the non-linear characteristic curves in this respect only need to be available for those sensor cells that are not defective according to said status information. The respective information is preferably available separately for each sensor cell, for example, in the form of a matrix that corresponds to the arrangement of the sensor cells in the image sensor. Thus, it may in particular be known for each sensor cell whether it is defective and, if it is not, with which gain correction offset and with which gain correction factor or according to which non-linear characteristic curve an image signal value generated by the respective sensor cell or a value of the preliminary image data derived therefrom is to be corrected.

According to a further advantageous embodiment, the metadata additionally comprise recording-specific data about operating conditions that were present during the generation of the image signal values and that are at least suitable for having an influence on the generation of the image signal values or that actually have an influence on the generation of the image signal values, wherein said correction additionally depends on the recording-specific data. The metadata may in particular comprise recording-specific data about deviations of the operating conditions from standard conditions in relation to which said camera model-generic (nominal) properties are defined.

The recording-specific data may in particular be physical variables that describe the circumstances of the generation of the image signal values. An example of recording-specific data is, for instance, the temperature, in particular the temperature of the image sensor and/or of the readout electronics, during the generation of the image signal values that may, for instance, have an influence on a noise of the image sensor and/or generally on the relationship between the intensity of the light incident on a respective sensor cell and the image signal value generated by the respective sensor cell in response thereto. Furthermore, the atmospheric pressure and/or a mechanical stress (static force application) and/or acceleration values (dynamic force application) may also have an influence on the generation of the image signal values.

According to a further advantageous embodiment, the provision of the camera specimen-specific data comprises the camera specimen-specific data being stored in a database, wherein the metadata transmitted to the external image processing device comprise identification information about the camera or parts thereof, in particular the image sensor and/or the readout electronics. In such an embodiment, the method comprises that the external image processing device reads out the camera specimen-specific data from the database based on the identification information and assigns the camera specimen-specific data to the transmitted preliminary image data. The identification information may, for example, be one or more serial numbers of the camera or a component thereof, in particular of the image sensor, the readout electronics and/or another electronic component of the camera, such as a relevant circuit board.

In this case, the metadata therefore do not need to directly comprise the camera-specific data since they may be obtained from the database. Specifically, based on the identification information transmitted as part of the metadata, the camera specimen used for generating the preliminary image data or its image sensor or its readout electronics may be identified so that the data specific to this camera specimen may be read out from the database and assigned to the preliminary image data. Subsequently, a correction dependent on these camera-specific data may then be applied to the preliminary image data. In such a case, the camera specimen-specific data may have been determined once, for example by a manufacturer of the camera, as part of a calibration for the respective camera specimen and stored in the database.

According to an advantageous further development of such an embodiment, the readout of the camera specimen-specific data from the database requires proof of a readout authorization, said proof received as part of a user input. The external image processing device may in particular be configured to receive user inputs in order to receive the proof of the readout authorization in this way. However, the user input does not necessarily have to be entered directly at the external image processing device, but the external image processing device may also receive it by transmission from another apparatus at which said user input was entered. The proof may, for example, be a password or a license key. However, it is generally also conceivable that knowledge of said identification information about the camera, the image sensor and/or the readout electronics is already regarded as proof of the readout authorization.

The proof may be received as part of the user input from the external image processing device. For example, the user input may consist of first requesting the generation of the processed image data and then entering the proof of the readout authorization. However, the proof may also be stored in advance in the external image processing device and may in this way be available as part of a later user input (request for processed image data).

A check of the readout authorization based on the proof may, for example, take place directly in the external image processing device or in the database. In other words: The external image processing device may be configured to check the proof of the readout authorization and to only read out the camera specimen-specific data from the database when the readout authorization is confirmed by the check; alternatively or additionally thereto, it may be provided that a check of the proof of the readout authorization (also) takes place in the database and the readout of the camera specimen-specific data from the database is only allowed if the readout authorization is confirmed by the check. In this way, in particular the generation of (fully) processed image data of a very high quality may be linked to the fact that a respective user has proof of the readout authorization. An unauthorized use of the image data, at least in high quality, may thus advantageously be prevented. At the same time, it may, however, be provided that partly processed image data of lower quality can be obtained even without said proof.

According to a further advantageous embodiment, the method further comprises partly processed image data being generated in the camera or by the external image processing device. After the generation of the partly processed image data, they may be output by the camera or the external image processing device.

The partly processed image data may be generated by applying a correction dependent on the camera specimen-specific data to a portion of the preliminary image data. However, this correction is not applied to the remaining portion of the image data, or at least not completely. This remaining portion may then be included in the partly processed image data either without the correction or with the incomplete correction or not at all (i.e. may simply be missing in the partly processed image data), wherein the latter is preferred.

For example, the correction may be limited to a subset of the pixels of a respective frame of the image data. The subset may correspond to a section, in particular a central section, of the respective frame. If the image data are moving image data that comprise a sequence of a plurality of frames, it may be the same section for all frames, i.e. the respective section has the same position and the same dimensions for each of the frames.

The subset of the image data to which a correction is applied may also be formed by a spatial subsampling, in particular by correcting only the pixels of every nth row and every mth column of a respective frame and leaving the remaining pixels uncorrected or omitted (where n and m are positive integers and preferably identical). If image data are omitted, the partly processed image data then have a reduced resolution compared to the resolution of the (fully) processed image data or to the resolution with which the image data were recorded.

In the case of moving image data, the subset of the image data to which a correction is applied may also be formed by a temporal subsampling, in particular by correcting only every nth frame and not correcting or omitting the remaining frames (where n is a positive integer). If frames are omitted, the partly processed image data then have a reduced frame rate compared to the frame rate of the (fully) processed image data or to the frame rate with which the image data were recorded.

In some embodiments, the preliminary image data may in particular correspond to a moving image sequence that comprises a sequence of a plurality of frames, wherein the partly processed image data are generated by applying a correction dependent on the camera specimen-specific data only to a portion of the preliminary image data that corresponds to a subset of the plurality of frames, whereas such a correction is not applied to the remaining portion of the preliminary image data that corresponds to the further ones of the plurality of frames. In such embodiments, the subset of the plurality of frames may correspond to a first frame rate of the moving image sequence, wherein the totality of the plurality of frames corresponds to a higher second frame rate of the moving image sequence. Thus, the partly processed image data may, for example, be displayed on a monitor device at a relatively low frame rate, while a display or further processing of the preliminary image data at a relatively higher frame rate requires a complete processing of the image data based on the camera specimen-specific data.

Two or more of these possibilities may also be combined. Compared to the (fully) processed image data, the partly processed image data may therefore be limited to a section, have a reduced resolution and/or a reduced frame rate.

In this respect, it is preferred if the portion of the preliminary image data to which the correction is applied is settable, for instance in that a respective section, a resolution and/or a frame rate can either be selected from a plurality of predefined possibilities or freely selected as a default for the partly processed image data.

The correction that is applied to a portion of the preliminary image data to generate the partly processed image data is preferably said correction dependent on the camera specimen-specific data that is also applied to the preliminary image data by the external image processing device in order to generate the (fully) processed image data. When generating the partly processed image data, the portion of the preliminary image data is therefore not corrected worse than when generating the (fully) processed image data, but the correction is comprehensive in both cases. The difference at least substantially only consists in that the correction is applied to all preliminary image data in one case and is applied only to a portion thereof or is partly applied in the other case.

If partly processed image data are generated in the camera or by the external image processing device, the external image processing device may generate the (fully) processed image data at a later point in time by applying the correction dependent on the camera specimen-specific data to the preliminary image data (in the form generated by the camera or in the partly processed form).

If partly processed image data have been generated, the generation of the (fully) processed image data may advantageously be limited to also applying the correction to the remaining portion of the preliminary image data and combining the result with the partly processed image data in order to obtain the (fully) processed image data overall. However, this is not necessarily the case since it is also conceivable that the partly processed image data are not used to generate the (fully) processed image data, but that the external image processing device applies the correction to the entire preliminary image data independently of the partly processed image data.

Compared to the (fully) processed image data, the partly processed image data may be generated with less computing effort, which is in particular advantageous for their generation in the camera. The partly processed image data may, for example, be used so that the progress or the result of a recording of image data may be examined directly at the camera or at a display device connected thereto without excessive effort. The generation of the (fully) processed image data outside the camera may then be linked to the proof of an authorization, in particular said readout authorization for the camera specimen-specific data. In this way, the generation of high-quality image data may be made dependent on the presence of an authorization, in particular in the form of a license key, without impairing the possibility of directly checking the progress or the result of a recording.

Alternatively or in addition to generating the partly processed image data by applying a correction (only) to a portion of the preliminary image data, the partly processed image data may also be generated by applying a different, in particular simpler, correction to the preliminary image data (whether to all the preliminary image data or only a portion thereof) than for the generation of the (fully) processed image data. In particular, partly processed image data may be generated in the camera or by the external image processing device by applying a simplified correction to the preliminary image data, said simplified correction being independent of the camera specimen-specific data or depending to a lesser extent on the camera specimen-specific data compared to said correction applied for the generation of the (fully) processed image data.

In some embodiments, the simplified correction may in particular be simplified precisely in that it is independent of the camera specimen-specific data.

In other embodiments, the simplified correction may depend to a lesser extent on the camera specimen-specific data compared to said (comprehensive) correction. The simplified correction may in particular depend on a smaller amount of camera specimen-specific data compared to said (comprehensive) correction. However, it may also be simplified in that it is limited to a correction of lower complexity than said (comprehensive) correction, for instance by performing the correction with parameters of lower result quality and/or simply omitting one or more parts of the correction. In this respect, the simplified correction may generally include all camera specimen-specific data that are also included in said (comprehensive) correction overall.

Preferably, the degree to which the simplified correction depends to a lesser extent on the camera specimen-specific data compared to said (full) correction is settable. In other words, in such a case, the degree to which the partly processed image data should already be processed may therefore be set. The range may in this respect extend from minimal partly processed to almost completely processed. It is generally also conceivable that it may be selectively set that the image processing device directly generates fully processed image data. Depending on the correction method used, said degree of processing may be quasi-continuously or even continuous settable.

If the simplified correction is even independent of the camera specimen-specific data, it may, for example, be limited to a mere interpolation (demosaicing) by which, for each pixel of the image data, values are calculated from values of adjacent pixels in those color channels in which no values are yet available for this pixel.

The partly processed image data generated by the simplified correction are generally of lower quality than the (fully) processed image data due to the lack of or less consideration of the camera specimen-specific data. The partly processed image data that were generated by correcting only a portion of the preliminary image data are also reduced in their quality compared to the (fully) processed image data since not all preliminary image data were (comprehensively) corrected in this case. In this regard, the partly processed image data are generally inadequate in both cases with regard to the image of very high quality that may ultimately be produced, for instance for a projection onto a movie screen. However, the partly processed image data may, for example, serve to generate control images with comparatively little effort that may already be used (for instance as a digital viewfinder image) during or shortly after a recording of image data for checking the image content, in particular for successfully realizing visual design objectives. Furthermore, the partly processed data may be used in the form of so-called proxies for preliminary cutting decisions, while the final cut is performed later using the (fully) processed image data of a very high quality.

If partly processed image data are generated, they may also be used for said generation of the (fully) processed image data by additionally applying a supplementary correction dependent on the camera specimen-specific data to the partly processed image data generated by the simplified correction. Therefore, the generation of the (fully) processed image data is then at least a two-stage process since the correction applied overall to the preliminary image data at least comprises the simplified correction, on the one hand, and the supplementary correction, on the other hand. More than two stages may also be provided, wherein the number of stages is preferably settable and/or the stage up to which the simplified correction should extend is settable. Furthermore, the generation of the (fully) processed image data may generally also be independent of the generation of partly processed image data.

According to an advantageous further development of the above embodiment, the external image processing device is configured to receive user inputs, wherein the external image processing device generates and/or (if the processed image data were already generated beforehand) outputs the processed image data in response to a first user input and generates and/or (if the partly processed image data were already generated beforehand) outputs the partly processed image data in response to a second user input different from the first user input. Depending on whether the external image processing device receives the first user input or the second user input, the (fully) processed image data generated by the correction dependent on the camera specimen-specific data or the partly processed image data generated by the simplified correction independent of the camera specimen-specific data or dependent to a lesser extent thereon are generated and/or output.

The designation of the user inputs as a first and second user input is in this respect not to be understood in terms of time or as a ranking, but serves for a conceptual differentiation between the two user inputs that may differ in terms of their type and/or content. In this respect, at least the first user input may comprise said proof of the readout authorization, if necessary.

A distinction may also be made between even more user inputs than only the first and the second user input, in response to which the external image processing device generates and/or outputs partly processed image data in each case and which differ from the second user input and from one another in that image data that are partly processed to different degrees in each case are generated and/or output, for example by applying a respective different simplified correction to the preliminary image data. The various simplified corrections may in particular differ with regard to whether and, if so, on which and/or on how much camera specimen-specific data they depend. In this way, the degree of processing of the image data and thus the quality of the respective resulting image may selectively be adapted to the respective requirements by a corresponding user input.

According to an advantageous further development, the partly processed image data (whether in the camera or by the external image processing device) are continuously generated and output to a monitor device at which said partly processed image data are continuously displayed. In particular, in the camera, preliminary image data may be continuously generated from which either partly processed image data are generated in the camera or which are transmitted to the external image processing device, where partly processed image data are generated therefrom; the partly processed image data are then likewise continuously output to a monitor device, where they are finally displayed. The monitor device may be a separate apparatus from the camera or an apparatus integrated into the camera, for example in the form of a digital viewfinder.

Due to the continuous processing of the image data, the image displayed at the monitor device may be a live image that enables a monitoring and immediate check of the recorded image contents during the recording of a moving image sequence (i.e. a sequence of a plurality of frames). Since the image data do not need to be fully processed for this purpose, it is sufficient if only partly processed image data are continuously generated and output to the monitor device. In this respect, the (fully) processed image data likewise do not have to be continuously generated, but may also only be generated at a later point in time, for instance as part of the general post-processing (post-production) of the image data.

Basically independently of the above embodiments, the method according to a further advantageous embodiment may further comprise that the preliminary image data are continuously transmitted (from the camera) to the external image processing device, while further preliminary image data are continuously generated in the camera. In other words, during the recording of a moving image sequence (sequence of a plurality of frames), in which preliminary image data are continuously generated in the camera, these preliminary image data are continuously transmitted, in particular in real time, to the external image processing device. In particular, the preliminary image data may in this respect be continuously transmitted to the external image processing device together with said metadata that comprise the camera specimen-specific data or at least allow an assignment of the camera specimen-specific data to the preliminary image data. However, it may also be sufficient if these metadata are only transmitted once to the external image processing device during a recording of a moving image sequence, for example at the beginning of the recording.

According to a further advantageous embodiment, the external image processing device comprises an on-set computing unit that is connected to the camera via a local data connection, preferably a high-bandwidth data connection. Such a high-bandwidth data connection may, for example, be characterized by data transmission rates of at least 1 Gbit/s, preferably of at least 10 Gbit/s, in particular of at least 100 Gbit/s, and may be provided by a local area network (LAN), for example. The local network may be a wired network, for example via Ethernet, a wireless network (WLAN; wireless local area network), for example in accordance with one of the standards of the IEEE 802.11 family of standards, or a partly wired and partly wireless network. However, the local, high-bandwidth data connection may generally also be realized by transmission by means of a storage medium, e.g. by a magazine swap.

The on-set computing unit is advantageously located in spatial proximity to the camera. In this regard, the on-set computing unit may in particular be an edge server. It may in particular be a computing unit that is operated on the set of a shoot. For the calculations performed by the on-set computing unit, in particular the application of said correction, the on-set computing unit may comprise an integrated circuit (IC), a microprocessor, a central processing unit (CPU), a graphics processing unit (GPU), an application-specific integrated circuit (ASIC) and/or a field programmable gate array (FPGA), or may at least substantially be formed thereby.

In this respect, it is preferred that the on-set computing unit generates and/or outputs the processed image data. Furthermore, it may be provided that the on-set computing unit alternatively or additionally thereto generates and/or outputs said partly processed image data or various image data that are partly processed (to various degrees). The on-set computing unit may in this respect be configured to automatically generate and/or output the processed and/or partly processed image data. However, it may also be provided that the on-set computing unit generates and/or outputs the processed and/or partly processed image data in response to a respective user input.

A further task of the on-set computing unit may be that the preliminary image data generated in the camera are temporarily stored in the on-set computing unit before the processed or partly processed image data are generated. At a later point in time, the processed or partly processed image data may then be generated from the temporarily stored preliminary image data so that the generation of the processed or partly processed image data may be decoupled in time from the generation of the preliminary image data. The preliminary image data temporarily stored in the on-set computing unit may also be transmitted at a later point in time to a computing unit and/or a memory of a cloud infrastructure (described in more detail below) to be further processed, in particular prepared, or again temporarily stored (for the time being) there.

According to a further advantageous embodiment, the external image processing device comprises a cloud infrastructure. Such a cloud infrastructure may in particular comprise a distributed arrangement of image processing devices and memory devices (e.g. a plurality of servers arranged in a distributed manner) that contribute a respective image processing capacity or storage capacity to the cloud infrastructure. In this way, image data including metadata may be transmitted to the cloud infrastructure in which camera specimen-specific data are determined based on the metadata, in particular are read out from a memory (e.g. a database) and are then used for generating the processed image data. After the generation, the processed image data may finally be output or retrieved from the cloud infrastructure. The cloud infrastructure is in this respect arranged remotely, i.e. at least spatially separately, from the camera. However, at least a part of the cloud infrastructure may generally also be located at the production site at which the image data are recorded.

Regardless of where the cloud infrastructure or the various parts of the cloud infrastructure is/are located, the camera is connected to the cloud infrastructure to be able to transmit image data and possibly further data, such as metadata, to the cloud infrastructure. This connection may in particular have a lower bandwidth than said connection between the camera and the on-set computing unit (if one is provided). The camera is preferably connected to the cloud infrastructure via a wide area network (WAN) or the internet (GAN; global area network). The respective network may, for example, be based on MPLS (multiprotocol label switching) as the switching method and/or on IP (internet protocol) as the network protocol. The camera may be connected to the cloud infrastructure directly or indirectly, in particular via said local network and possibly via said on-set computing unit. The cloud infrastructure may comprise one or more computing units (servers) as well as memories and/or databases. In particular, the cloud infrastructure may comprise said database in which the camera specimen-specific data may be stored.

In this respect, it is preferred that the cloud infrastructure comprises a computing unit that generates and/or outputs the processed image data. The computing unit that may be configured as a cloud server may comprise an integrated circuit (IC), a microprocessor, a central processing unit (CPU), a graphics processing unit (GPU), an application-specific integrated circuit (ASIC) and/or a field programmable gate array (FPGA) or may at least substantially be formed thereby. If the cloud infrastructure comprises a plurality of computing units, each of the computing units may in each case be designed in this way.

Furthermore, it may be provided that said computing unit of the cloud infrastructure generates and/or outputs said partly processed image data or image data partly processed to various degrees as an alternative to or in addition to generating or outputting the processed image data. The processing unit may in this respect be configured to automatically generate and/or output the processed or partly processed image data. However, it may also be provided that the processing unit generates and/or outputs the processed or partly processed image data in response to a respective user input.

According to a further advantageous embodiment, the cloud infrastructure is connected to the local network via the wide area network or the internet and is connected to the on-set computing unit, in particular via the local network. In this regard, the cloud infrastructure may also be connected to the camera in that the cloud infrastructure is connected to the wide area network or the internet and the camera is connected to the local network, wherein the local network is connected to the wide area network or the internet.

According to a further advantageous embodiment, the preliminary image data are transmitted to a memory of the cloud infrastructure together with the metadata, are stored in the memory, and are read out from the memory for the generation of the processed image data and/or for a generation of partly processed image data. In other words, in this embodiment, said transmission of the preliminary image data together with the metadata to the external image processing device comprises transmitting the preliminary image data together with the metadata to said memory and storing them in this memory; furthermore, in this embodiment, said generation of processed image data or partly processed image data comprises first reading out the preliminary image data, in particular again together with the metadata, from the memory before the corresponding correction is applied thereto. The generation of processed or partly processed image data may in particular take place by means of said on-set computing unit, by means of said computing unit of the cloud infrastructure, or by means of another computing unit of the external image processing device, wherein the preliminary image data are preferably read out from the memory by this respective computing unit.

According to a further advantageous embodiment, the method further comprises the preliminary image data being scrambled during their generation in dependence on the camera specimen-specific data by bringing the preliminary image data into an irregular order relative to a regular order. The regular order may, for example, correspond to the arrangement of the sensor cells along rows and/or columns along the image sensor, or the arrangement of row amplifiers and/or column amplifiers of the image sensor, or the arrangement of analog/digital converters of the image sensor or of the readout electronics separate therefrom. In such embodiments, the metadata may comprise information about the scrambling and the correction dependent on the camera specimen-specific data may comprise descrambling the preliminary image data again based on the information about the scrambling by bringing the preliminary image data into the regular order, starting from the irregular order.

The scrambling may generally only take place in the external image processing unit, for example if it serves a kind of encryption of the image data. However, the scrambling preferably takes place in the camera or at least before the transmission to the external image processing device, in particular if it serves to conceal deviations between different components of the readout electronics, such as row or column amplifiers (i.e. amplifiers that are each assigned to an entire row or column of sensor cells of the image sensor).

This is because if individual row or column amplifiers amplify the image signal values generated by the sensor cells in the respective row or column to a greater or lesser extent than adjacent row or column amplifiers, these rows or columns may appear in the image as lighter or darker stripes compared to their surroundings. This may be avoided by the scrambling by shifting the image signal values of a respective row or column, depending on their position within the row or column, into a (closer or further) neighboring row or column so that they are amplified by means of the row or column amplifier of the neighboring row or column and the rows or columns are “scrambled” in this regard (cf., for example, DE 10 2007 058 973 A1 or DE 10 2007 027 463 A1). In the respective frame, consecutive columns or rows are shifted relative to one another to different degrees (along their respective longitudinal direction) as a result of the scrambling so that lighter or darker stripes running perpendicular to this shift that are caused by deviations between the row or column amplifiers are distributed over a plurality of rows or columns after the shift has been reversed (descrambling) and are so-to-say blurred. The scrambling thus leads to the deviations having a less noticeable effect on the image.

In particular since the deviations between the row or column amplifiers are usually camera specimen-specific, the pattern according to which the scrambling takes place (i.e. which row or column is shifted how far) may also be camera specimen-specific. In this regard, said information about the scrambling may in particular comprise this respective pattern that is then incorporated as part of the camera specimen-specific data into the correction dependent on the camera specimen-specific data that includes the descrambling. If the image data are moving image data, the pattern may furthermore vary over time, i.e. it does not necessarily have to be the same for a plurality of consecutive frames, wherein the temporal dependency of the pattern may also be camera specimen-specific and thus part of the camera specimen-specific data.

It may generally furthermore be provided that the described generation of partly processed image data also comprises the preliminary image data being descrambled again based on the information about the scrambling. Similarly to as already described further above, the respective correction may in this respect be limited to only a portion of the scrambled preliminary image data being descrambled again. In the case of moving image data, this may in particular mean that—as already generally described—not all frames are descrambled again when generating the partly processed image data, but that the descrambling is limited to a portion of the image data that is sufficient for playing back the image data at a reduced frame rate compared to the frame rate at which the image data were recorded. For example, it may be provided that the image sensor is controlled to generate the image signal values at a frame rate of 60 fps (frames per second) or 120 fps so that the preliminary image data that are generated therefrom and scrambled likewise have this frame rate. When generating the partly processed image data, for example, only every second or fourth frame of the preliminary image data is then descrambled again, whereas the remaining frames are not descrambled or are simply omitted so that the partly processed image data have a correspondingly reduced frame rate of 30 fps, for example. Such partly processed image data with a reduced frame rate may then be displayed on a monitor device (for example in an electronic viewfinder or on a monitor) so that a recording may be checked quickly with comparatively little effort.

The invention will be explained further in the following only by way of example with reference to the Figures.

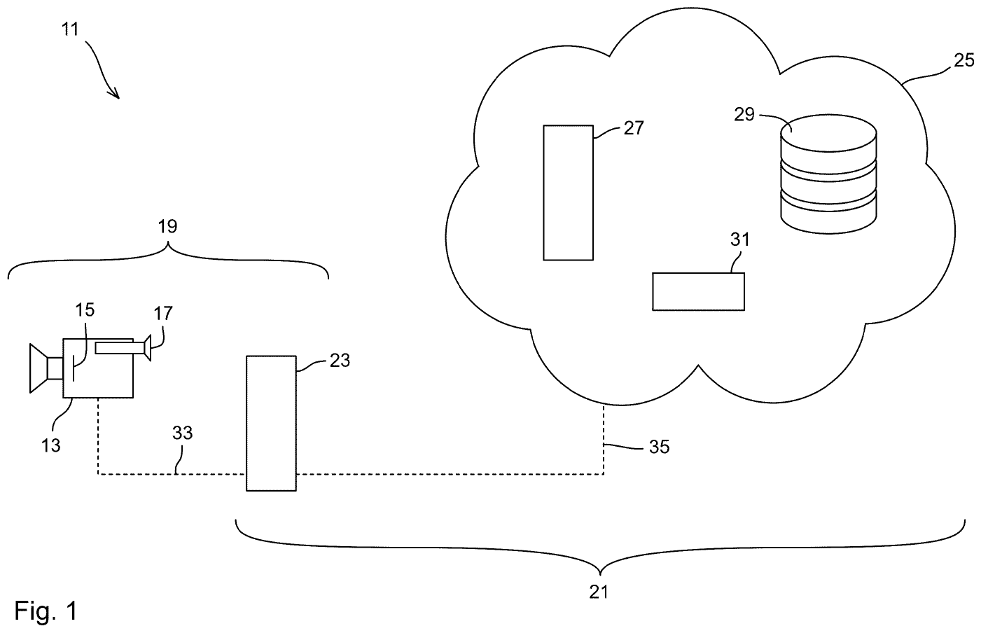

FIG. 1 shows an image recording system in a simplified schematic representation that is configured to execute one embodiment of the method according to the invention; and

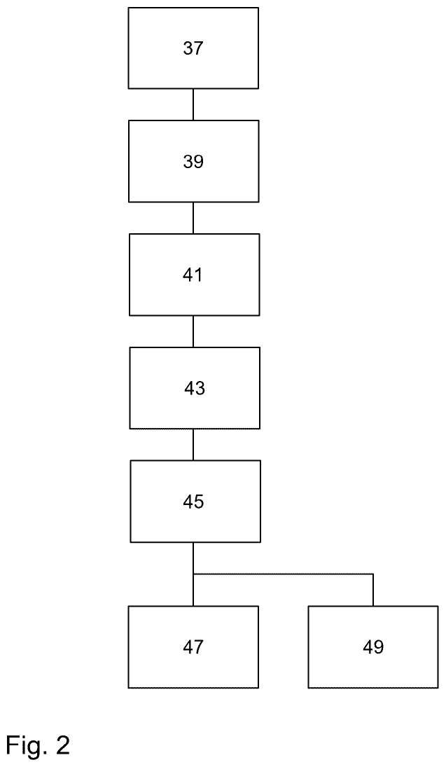

FIG. 2 illustrates, in a schematic representation, the sequence of an embodiment of the method according to the invention.

In FIG. 1, an image recording system 11 is shown by means of which image data may be generated and processed. The generation of the image data takes place by means of a camera 13 of the image recording system 11 that comprises an image sensor 15. The camera 13 furthermore comprises an electronic viewfinder 17. The camera 13 is part of a set 19 at which, for example, a scene (not shown) is recorded by means of the camera 13. The image recording system 11 further comprises an external image processing device 21 formed separately from the camera 13.

In the embodiment shown, the external image processing device 21 comprises, on the one hand, an on-set computing unit 23, which acts as an edge server, and, on the other hand, a cloud infrastructure 25 that in turn comprises one or more computing units 27, databases 29 and/or memories 31. The on-set computing unit 23 is in this respect located on the set 19 and is connected via a local network 33 to the camera 13 so that it may receive image data from the camera 13 via the local network 33. The connection between the camera 13 and the on-set computing unit 23 via the local network 33 may be wired or wireless in this respect. However, the cloud infrastructure 25 is remote from the set 19 and may in particular also be distributed across different locations, such as different data centers. The cloud infrastructure 25 is connected to the on-set computing unit 23 via the internet 35, wherein this connection may be present in that the cloud infrastructure 25 is connected to the local network 33 via the internet 35. The connection between the camera 13 and the on-set computing unit 23 via the local network 33 in this respect has a higher bandwidth than the connection to the cloud infrastructure 25 via the internet.

The image recording system 11 is configured to carry out a method according to the invention. A possible embodiment of the method according to the invention is illustrated in FIG. 2 in which individual steps 37-49 of the method are shown as blocks.

In a step 37 of the method, camera specimen-specific data about determined properties of the camera 13, in particular of the image sensor 15, of individual sensor cells of the image sensor 15 and/or of readout electronics of the camera 13, are provided that may deviate from camera model-generic properties of the camera 13, in particular of the image sensor 15, of the individual sensor cells or of the readout electronics. For example, the camera specimen-specific data may be provided by storing them in the database 29 of the cloud infrastructure 25. From there, they may then be read out based on identification information about the respective camera specimen, i.e. about the specifically used camera 13.

The method further comprises the step 39 in which the image sensor 15 is controlled to generate respective image signal values in dependence on the intensity of the light incident on the sensor cells. Furthermore, the method comprises the step 41, in which the image signal values are read out in the camera 13, and the step 43 in which preliminary image data are generated in the camera 13 from the image signal values.

In a further step 45 of the method, the preliminary image data are transmitted to the external image processing device 21, namely at least initially to the on-set computing unit 23 in the example shown, together with metadata that comprise the camera specimen-specific data or at least, for instance in the form of said identification information, allow an assignment of camera specimen-specific data stored in the database 29 to the preliminary image data. The external image processing device 21 then generates processed image data in a step 47 of the method by applying a correction dependent on the camera specimen-specific data to the preliminary image data, wherein this may take place in the on-set computing unit 23 and/or in a computing unit 27 of the cloud infrastructure 25.

Furthermore, in the embodiment of the method shown, it is provided that the external image processing device 21 may also generate only partly processed image data in a further step 49 by applying a simplified correction to the preliminary image data, said simplified correction being independent of the camera specimen-specific data or depending at least to a lesser extent on the camera specimen-specific data compared to the correction applied for generating the (fully) processed image data in step 47. Alternatively thereto, in step 49, partly processed image data could also be generated in the camera by applying a correction dependent on the camera specimen-specific data to only a portion of the preliminary image data. Subsequent to the generation of the processed image data or partly processed image data, said data may be saved and/or output in each case.

In particular, it may further be provided that the image sensor 15 is controlled to continuously generate image signal values which are continuously read out in the camera 13 and from which preliminary image data are continuously generated that are then continuously transmitted to the external image processing device 21. The external image processing device 21 may continuously generate partly processed image data from the transmitted preliminary image data and may output the partly processed image data to a monitor device, in particular said electronic viewfinder 17 of the camera 13, on which said data are continuously displayed. In this way, the image data may already be viewed as a live image in a partly processed form during their recording. Alternatively or in addition to the display at the viewfinder 17, the partly processed image data may also be continuously output to a monitor device separate from the camera 13 and may then be displayed thereat.

Whether (fully) processed image data and/or only partly processed image data are generated, may in this respect depend on whether the external image processing device 21 receives a first user input or a second user input. Due to the respective user input, the extent to which the image data are to be processed may thus advantageously be selected so that the method makes it possible that images of different quality may be obtained as required.

### REFERENCE NUMERALS

11 image recording system
13 camera
15 image sensor
17 viewfinder
19 set
21 external image processing device
23 on-set computing unit
25 cloud infrastructure
27 computing unit
29 database
31 memory
33 local network
35 internet
37-49 method steps

1. A method for generating image data by means of a camera and for processing the image data by means of an external image processing device,
wherein the camera comprises an image sensor, which has a plurality of light-sensitive sensor cells arranged in rows and columns, and readout electronics, and
wherein the method comprises the steps:
providing camera specimen-specific data about determined properties of the camera that may deviate from camera model-generic properties of the camera;
controlling the image sensor to generate respective image signal values in dependence on an intensity of light incident on the light-sensitive sensor cells;
reading out the image signal values and generating preliminary image data from the image signal values in the camera;
transmitting the preliminary image data to the external image processing device together with metadata that comprise the camera specimen-specific data or at least allow an assignment of the camera specimen-specific data to the preliminary image data; and
generating processed image data in the external image processing device by applying a correction dependent on the camera specimen-specific data to the preliminary image data.

2. A method according to claim 1,
wherein the camera specimen-specific data relate to at least one of:
properties of the image sensor, properties of the readout electronics, or individual properties of the individual light-sensitive sensor cells of the image sensor.

3. A method according to claim 1,
wherein the camera specimen-specific data comprise at least one of:
gain correction offsets of the light-sensitive sensor cells, gain correction factors of the light-sensitive sensor cells, status information about defective light-sensitive sensor cells of the image sensor, or parameters of non-linear characteristic curves of the light-sensitive sensor cells of the image sensor.

4. A method according to claim 1,
wherein the metadata additionally comprise recording-specific data about operating conditions that were present during the generation of the image signal values and that are suitable for having an influence on the generation of the image signal values, and
wherein said correction applied to the preliminary image data additionally depends on the recording-specific data.

5. A method according to claim 1,
wherein the provision of the camera specimen-specific data comprises the camera specimen-specific data being stored in a database,
wherein the metadata transmitted to the external image processing device comprise identification information about the camera or parts of the camera, and
wherein the method comprises that the external image processing device reads out the camera specimen-specific data from the database based on the identification information and assigns the camera specimen-specific data to the transmitted preliminary image data.

6. A method according to claim 5,
wherein the readout of the camera specimen-specific data from the database requires proof of a readout authorization, said proof received as part of a user input.

7. A method according to claim 1,
that further comprises:
partly processed image data being generated in the camera or by the external image processing device.

8. A method according to claim 7,
wherein the partly processed image data are generated by applying the correction dependent on the camera specimen-specific data to a portion of the preliminary image data.

9. A method according to claim 8,
wherein the portion of the preliminary image data to which the correction is applied can be set.

10. A method according to claim 7,
wherein the preliminary image data correspond to a moving image sequence that comprises a sequence of a plurality of frames, wherein the partly processed image data are generated by applying the correction dependent on the camera specimen-specific data only to a portion of the preliminary image data that corresponds to a subset of the plurality of frames, whereas the correction is not applied to the remaining portion of the preliminary image data that corresponds to the further ones of the plurality of frames.

11. A method according to claim 10,
wherein the subset of the plurality of frames corresponds to a first frame rate of the moving image sequence, wherein the totality of the plurality of frames corresponds to a second frame rate of the moving image sequence, and wherein the second frame rate is higher than the first frame rate.

12. A method according to claim 7,
wherein the partly processed image data are generated by applying a simplified correction to the preliminary image data, said simplified correction depending to a lesser extent on the camera specimen-specific data compared to the mentioned correction.

13. A method according to claim 7,
where the partly processed image data are generated by applying a simplified correction to the preliminary image data, said simplified correction being independent of the camera specimen-specific data.

14. A method according to claim 7,
wherein the external image processing device is configured to receive user inputs, and
wherein the external image processing device generates and/or outputs the processed image data in response to a first user input and generates and/or outputs the partly processed image data in response to a second user input.

15. A method according to claim 7,
that further comprises:
the partly processed image data being continuously generated and output to a monitor device at which said partly processed image data are continuously displayed.

16. A method according to claim 1,
that further comprises:
partly processed image data being generated by the external image processing device,
wherein the preliminary image data are continuously transmitted to the external image processing device, while further preliminary image data are continuously generated in the camera, and
wherein the external image processing device continuously generates the partly processed image data and outputs them to a monitor device on which the partly processed image data are continuously displayed.

17. A method according to claim 1,
wherein the external image processing device comprises an on-set computing unit that is connected to the camera via a local data connection, wherein the on-set computing unit generates and/or outputs the processed image data.

18. A method according to claim 1,
wherein the external image processing device comprises a cloud infrastructure to which the camera is connected via a wide area network (WAN) or the internet, wherein the cloud infrastructure comprises a computing unit that generates and/or outputs the processed image data.

19. A method according to claim 18,
wherein the external image processing device comprises an on-set computing unit that is connected to the camera via a local data connection, wherein the cloud infrastructure is connected to the on-set computing unit via the wide area network or the internet.

20. A method according to claim 18,
wherein the provision of the camera specimen-specific data comprises the camera specimen-specific data being stored in a database,
wherein the metadata transmitted to the external image processing device comprise identification information about the camera including parts of the camera, and
wherein the method comprises that the external image processing device reads out the camera specimen-specific data from the database based on the identification information and assigns the camera specimen-specific data to the transmitted preliminary image data,
wherein the cloud infrastructure comprises said database.

21. A method according to claim 18,
wherein the preliminary image data are transmitted to a memory of the cloud infrastructure together with the metadata, are stored in the memory, and are read out from the memory for the generation of the processed image data.

22. A method according to claim 1,
that further comprises:
that the preliminary image data are scrambled during their generation in dependence on the camera specimen-specific data by bringing the preliminary image data into an irregular order relative to a regular order, wherein the metadata comprise information about the scrambling; and
that the correction dependent on the camera specimen-specific data comprises descrambling the preliminary image data again based on the information about the scrambling by bringing the preliminary image data into the regular order, starting from the irregular order.

23. A method for generating image data by means of a camera and for processing the image data by means of an external image processing device,
wherein the camera comprises an image sensor, which has a plurality of light-sensitive sensor cells arranged in rows and columns, and readout electronics, and
wherein the method comprises the steps:
controlling the image sensor to generate respective image signal values in dependence on an intensity of light incident on the light-sensitive sensor cells;
reading out the image signal values and generating preliminary image data from the image signal values within the camera;
transmitting the preliminary image data from the camera to the external image processing device together with metadata that comprise identification information about the camera or parts of the camera;
reading out camera specimen-specific data from a database into the external image processing device, wherein the readout of the camera specimen-specific data from the database takes place based on the transmitted identification information and requires proof of a readout authorization, said proof received by a user input;
assigning the read-out camera specimen-specific data to the transmitted preliminary image data; and
generating processed image data in the external image processing device by applying a correction dependent on the camera specimen-specific data to the preliminary image data.

24. A method for generating image data by means of a camera and for processing the image data by means of an external image processing device,
wherein the camera comprises an image sensor, which has a plurality of light-sensitive sensor cells arranged in rows and columns, and readout electronics, and
wherein the method comprises the steps:
providing camera specimen-specific data about properties of the camera;
controlling the image sensor to generate respective image signal values in dependence on an intensity of light incident on the light-sensitive sensor cells;
reading out the image signal values and generating preliminary image data from the image signal values in the camera, wherein the preliminary image data are scrambled in dependence on the camera specimen-specific data by bringing the preliminary image data into an irregular order relative to a regular order;
transmitting the preliminary image data to the external image processing device together with metadata that comprise the camera specimen-specific data or at least allow an assignment of the camera specimen-specific data to the preliminary image data; and
generating processed image data in the external image processing device by applying a correction dependent on the camera specimen-specific data to the preliminary image data, wherein the correction comprises descrambling the preliminary image data again based on information about the scrambling derived from the metadata by bringing the preliminary image data into the regular order, starting from the irregular order.
